(19) United States
(12) Patent Application Publication
(10) Pub. No.: US 2002/0015769 A1
(43) Pub. Date: Feb. 7, 2002

(54) Tubular food casing

(76) Inventors: Anton Krallmann, Fallingbostel (DE); Gerhard Decker, Walsrode (DE)

Correspondence Address: Patent Department, Bayer Corporation, 100 Bayer Road, Pittsburgh, PA, 15205-9741, US

(21) Appl. No.: 09/886,082

(22) Filed: Jun. 20, 2001

(30) Foreign Application Priority Data
Jun. 26, 2000 (DE) 10031045.1

(51) Int. Cl. A23L 1/31

(52) U.S. Cl. 426/277; 138/118.1; 426/278

(57) ABSTRACT

Described is a tubular food casing, e.g., a tubular cellulose-hydrate food casing, treated with a mixture comprising water, acetic acid and peracetic acid. Also described is a method of sanitizing a cellulose based tubular food casing comprising, moistening the cellulose based tubular food casing, prior to gathering of the food casing, with a mixture comprising water, hydrogen peroxide, acetic acid and peracetic acid.

### FIELD OF THE INVENTION

The invention relates to a tubular food casing, in particular a synthetic sausage casing, composed, for example, of pure cellulose or of a cellulose hydrate, that has been treated with a mixture comprising water, acetic acid and peracetic acid.

### BACKGROUND OF THE INVENTION

Food casings which consist, for example, of cellulose hydrate can become unusable during storage on the premises of the manufacturer, the formulator and/or the processor as a result of infestation with undesirable mould fungi and micro-organisms.

The risk becomes all the greater, the higher the setting of the moisture content of the sausage casings. Unfavorable storage parameters, such as high room temperature, accelerate the undesirable growth of micro-organisms.

For an intermediate process of formulation, particularly in the course of gathering, it is absolutely essential to moisten the cellulose casing or cellulose-fiber casing, with and without a barrier layer, in order to guarantee an adequate flexibility of the casing for this process. At this stage the merchandise is therefore highly susceptible to microbiological infestation.

With a view to preventing this danger, it is known to apply glycerol monolaurate on the outer surface of cellulose tubes as a fungicidal agent (EP-A-0 141 066, U.S. Pat. No. 4,662,403). In comparison with water-soluble fungicidal compounds, this compound has the advantage that it is still present in sufficient quantity on the outer surface also after processing of the casing, in particular also after hot-water treatment of the sausage casing which is filled with sausage meat. With this fungicidal agent the sausages with a sausage skin consisting of cellulose which are enclosed in a secondary packaging, for example in a plastic bag, are also intended to be protected against the undesirable infestation of the cellulose layer with mould fungi.

Moreover, from DE-A-1 900 343 it is known that an agent consisting of a didecyldimenthylammonium compound is applied on the cellulose tubes in a quantity amounting to about 10 mg/m², in particular about 20 mg/M², it also being possible to employ reduced quantities, amounting to below 20 or even below 15 mg/m², of this fungicidal compound, provided that the action thereof is intensified by addition of other fungicidal compounds. For sausage casings that are treated with water before or after filling, a higher applied quantity is required. In general a minimum quantity of 60, in particular 80 mg/m², is then required. With respect to the upper limit of the applied quantity, regulations prescribed by the law relating to food have to be complied with. In general, the applied quantity of 300, in particular 200 mg/m², is not exceeded.

From DE-A 32 20 488 it is known that use of compounds containing peroxo groups, applied with the aid of dipping processes or with the aid of spraying processes at the gathering machine, in connection with glycerin and a high water content reduces the susceptibility of the cellulose-fiber casing to germs.

All these agents have the disadvantage that they can influence the quality of the product (e.g., sausage meat) to be packaged, and can also be detected in said product.

### SUMMARY OF THE INVENTION

The object of the present invention was to make available a tubular food casing that is substantially sterile during storage prior to filling, and that releases no noxious substances to the filling after being filled with the food commodity.

In accordance with the present invention, there is provided a tubular food casing treated with a mixture comprising water, acetic acid and peracetic acid.

In accordance with the present invention, there is further provided a method of sanitizing a cellulose based tubular food casing comprising, treating said cellulose based tubular food casing, prior to gathering of said cellulose based tubular food casing, with a mixture comprising water, hydrogen peroxide, acetic acid and peracetic acid.

Other than in the operation examples, or where otherwise indicated, all numbers expressing quantities of ingredients, reaction conditions, and so forth used in the specification and claims are to be understood as modified in all instances by the term “about.”

### DETAILED DESCRIPTION OF THE INVENTION

The charging of small quantities of peracetic acid to the moistening medium (water) keeps the casing substantially sterile even at extremely low concentration. As a result of the chemical conversion of peracetic acid into the constituents water, oxygen and acetic acid, which takes place spontaneously, the passing of extraneous substances over to the casing and to the meat product, e.g., sausage meat, contained within the casing is essentially eliminated. Acetic acid is listed as a preservative under the denomination E260.

Peracetic acid is typically never present as a single substance but is always a mixture of the following four substances: peracetic acid, acetic acid, hydrogen peroxide and water. With a high concentration of peracetic acid, these four components are in a state of thermodynamic equilibrium. For the use according to the present invention, the peracetic acid is very highly diluted (e.g., an aqueous solution containing less than 0.05 percent by weight of peracetic acid, based on the total weight of the aqueous solution) so that it ceases to be in a state of equilibrium. Under conditions of high dilution, peracetic acid is converted to acetic acid, with the concurrent elimination of radical oxygen. The highly lipid-soluble molecules of peracetic acid therefore readily penetrate many cell membranes and bring their active oxygen to the unprotected, oxidation-sensitive metabolic enzymes contained therein. As a result of this efficient type of effect on germs and microorganisms, the concentration of the peracetic acid can be kept very low when sanitizing the food casings of the present invention.

Ordinarily, the starting-point is an initial mixture, e.g., a stock solution, that typically contains 38 to 44 wt. % peracetic acid, 12 to 16 wt. % hydrogen peroxide and also 20 to 25 wt. % acetic acid as well as water, based on the total weight of the initial mixture. Mixtures of such a type are commercially available (e.g., under the tradename Wofasteril® E400). For the use according to the present invention, this initial mixture is appropriately diluted by a factor of 1,000 to 2,000 with deionized water.

A further advantage of this system is the settable time in which the process of the conversion of peracetic acid into acetic acid is concluded. This period of time is directly related to the pH value of the solution. In the neutral range the conversion takes significantly longer than in the acidic range. This relationship is a very great advantage for use in practice. Application of the peracetic acid on the casing takes place in the intermediate process constituted by moistening. With the moistening it is ensured that the casing has adequate flexibility for this process. Immediately after moistening of the tubular casing, the casing has a low germ count.

Since moistening and gathering operations are not performed on the same machines, a certain period of time will typically have elapsed between these operations. In addition, it is also important for the subsequent processes, here the gathering process, that a certain proportion of active peracetic acid that has not yet been converted into acetic acid remains in the tubular casing. This active peracetic acid prevents growth of germs in respect of those germs which could be applied on the casing from outside, for example in the course of the gathering process or in the course of manual removal of the tubular casings.

The peracetic acid that has not yet been converted will kill the germs on the casing that were transferred in the course of the gathering process. This treated casing product is then packaged, under conditions that are as sterile as possible, in a carton with or without an inner bag composed of water-impermeable material such as polyethylene or polypropylene, for example.

The food casing of the present invention may be selected from a cellulose casing, a cellulose-hydrate casing, a regenerated cellulose casing and a polyamide casing. The food casing of the present invention may optionally also contain barrier layers. The present invention also encompasses casings that do not have to be hydrated.

The casing material preferably comprises cellulose, in particular cellulose-hydrate, which is also referred to as regenerated cellulose or transparent cellulose film. The cellulose layer preferably contains in its wall a fibrous reinforcement, e.g., hemp-fiber paper, which is covered with cellulose on one surface or on both surfaces.

Food casings composed of cellulose may be produced in a conventional manner, for example in accordance with the art-recognized viscose process. In this process, viscose is extruded through a ring nozzle, or a fibrous web that has been formed into a tube, e.g., consisting of paper or hemp fibers, is coated by a ring nozzle on the inside and/or outside with alkaline viscose solution and the viscose is treated with an acidic precipitating liquid which brings about coagulation of the viscose. The viscose solution optionally contains the dyestuff pigments that are required for the purpose of forming a white or colored casing. For the purpose of producing reinforcement-free cellulose casings, the extruded viscose is squeezed out directly into the precipitating bath.

Prior to drying, the optionally fiber-reinforced tube consisting of cellulose-hydrate gel that is obtained can be provided on its outside with the treatment that is essential to the present invention. Application of the mixture comprising water, acetic acid and peracetic acid to the food casing may be performed in a conventional manner, e.g. by steeping in a liquid bath, by roller coating or spraying.

The concentration of the peracetic acid in the aqueous treatment mixture amounts overall to 0.02 to 0.04 wt. %, based on the total weight of the treatment mixture. The aqueous treatment mixture also contains water in an amount of from 99.98 wt. % to 99.96 wt. %, and acetic acid in an amount of from 0.02 wt. % to 0.04 wt. %, based on the total weight of the aqueous treatment mixture.

If a sodium salt, such as sodium sorbate, is also employed in addition for the purpose of reinforcing the fungicidal action, the proportion in the aqueous treatment mixture is adjusted in accordance with the desired composition of the layer.

If the aqueous treatment mixture is applied to the food casing in a bath during production of the casing, it typically also contains one or more plasticisers for the cellulose, in particular monohydric or polyhydric alcohols such as, glycerin, propanediol (propylene glycol) or ethanol or mixtures thereof in conventional quantity

If the aqueous treatment mixture is applied to the food casing in a spraying process during production of the casing, it typically also contains one or more components for the cellulose, in particular monohydric or polyhydric alcohols such as, for example, glycerin, propanediol (propylene glycol) or mixtures thereof in conventional quantity. Then, as usual, the tube is dried and temporarily stored in the inflated state.

For an intermediate process of formulation, particularly in the course of gathering, it is absolutely essential to moisten the product in order to guarantee an adequate flexibility of the casing for this process. As a rule, this increase in moisture is obtained by supplying water in a quantity from 25 to 35 wt. %, relative to the dry weight of the casing. In this connection the conventional processes such as dipping and spraying may find application. For externally lacquered fibrous casings the moistening can also be carried out by means of the art-recognized blowing method.

With a concentration of peracetic acid from 0.01 to 0.1 wt. %, and in particular from 0.02 to 0.04 wt. %, relative to the weight of the moistening liquid (i.e., the aqueous treatment mixture), the tubular casing can be given the effective protection against germs.

The premoistened tube is gathered using a conventional gathering device, whereby the gathering machine, but in particular the parts coming into contact with the casing, have been subjected to thorough cleaning and disinfection. Also important is the low-germ-count handling of the appropriate machines.

### EXAMPLES

The caterpillars that are obtained in the following Examples are stored for several months in an airtight, moisture-impermeable film bag at about 25-30° C. The caterpillars were analyzed and the results are summarized in Table 1.

### Example 1

A Kaliber 39 Walsroder FR® fibrous casing was moistened with an aqueous treatment mixture containing 0.01 wt. % of peracetic acid, and 99.97 wt. % of water, based on the total weight of the aqueous treatment mixture. The aqueous treatment mixture was prepared by diluting a stocks solution containing 42 wt. % of peracetic acid, based on the total weight of the stock solution, with water. The pH of the aqueous treatment solution was 2. Upon completion of the moistening step, the fibrous casing was determined to have a moisture content of 30 wt. %, based on the dry weight of the fibrous casing. After 2 weeks this casing was gathered on a disinfected gathering machine to 32 mm tube and wrapped in a net and packaged in a 100 μm polyethylene bag.

### Comparative Example 1

A Kaliber 39 Walsroder FR® fibrous casing was moistened with an aqueous treatment mixture containing 0.03 wt. % citric acid, 0.02 wt. % sodium benzoate, and 99.95 wt. % water, based on the total weight of the aqueous treatment mixture. Upon completion of the moistening step, the fibrous casing was determined to have a moisture content of 30 wt. %, based on the dry weight of the fibrous casing.

After 2 weeks this casing was gathered on a disinfected gathering machine to 32 mm tube and wrapped in a net and packaged in a 100 μm polyethylene bag.

### Example 2

A Kaliber 39 Walsroder FR® fibrous casing was moistened with an aqueous treatment mixture containing 0.02 wt. % of peracetic acid, and 99.98 wt. % of water, based on the total weight of the aqueous treatment mixture. The aqueous treatment mixture was prepared by diluting a stock solution containing 42 wt. % of peracetic acid, based on the total weight of the stock solution, with water. Upon completion of the moistening step, the fibrous casing was determined to have a moisture content of 30 wt. %, based on the dry weight of the fibrous casing. In addition, the pH value of this solution was adjusted from 2 to about 7 with sodium benzoate.

After a duration of moistening of 2 weeks this casing was gathered on a disinfected gathering machine to 32 mm tube, wrapped in a net and packaged in a 100 μm polyethylene bag.

Test Methods

1. Measurement of Germs

The measurement of germs is carried out with the aid of a test strip available from Merck under the trade name Envirocheck® Contakt YM(S)

The surface of the tubular casing to be tested is contacted by the test strip and subsequently this test strip is stored at 30° C. in a heat chamber. By comparing the stored sample with the chart which is also supplied by the manufacturer, Merck, the magnitude of the bacterial growth can be stated in CFU/cm² (CFU=Colony Forming Units).

TABLE 1

| | Compar- | | |
|---|---|---|---|
| | ative | | |
| | Example 1 | Example 1 | Example 2 |
| No. | Walsroder | Walsroder | Walsroder |
| Casing product | FR® 39 | FR® 39 | FR® 39 |
| Moisture content | 30 | 30 | 30 |
| after moistening | | | |
| (wt. %) | | | |
| Concentration: | 0.03 citric | 0.01% peracetic | 0.02% peracetic |
| (wt. %) | acid and | acid at pH | acid at pH |
| disinfectant | 0.02 sodium | value = 2. | value = 7. |
| | benzoate | | |
| | At pH | | |
| | value = 2 | | |
| Measurement of | 0.6 CFU/cm² | Not measurable | Not measurable |
| number of germs | | | |
| on surface of | | | |
| casing after | | | |
| gathering | | | |
| Measurement of | 2.3 CFU/cm² | Not measurable | Not measurable |
| number of germs | | | |
| on surface of | | | |
| casing after a | | | |
| waiting-time of 2 | | | |
| weeks after | | | |
| gathering | | | |
| Measurement of | 6.0 CFU/cm² | 0.6 CFU/cm² | Not measurable |
| number of germs | | | |
| on surface of | | | |
| casing after a | | | |
| waiting-time of 4 | | | |
| weeks after | | | |
| gathering | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A tubular food casing treated with a mixture comprising water, acetic acid and peracetic acid.

2. The food casing of claim 1 wherein said food casing is a cellulose-hydrate casing.

3. The food casing of claim 1 wherein the food casing is gathered.

4. The food casing of claim 1 wherein the mixture of water, hydrogen peroxide, acetic acid and peracetic acid contains 0.02 to 0.04 wt. % peracetic acid, based on the weight of said mixture.

5. The food casing of claim 1 wherein said food casing is packaged in a protective package comprising a water-impermeable material.

6. A method of sanitizing a cellulose based tubular food casing comprising, treating said cellulose based tubular food casing, prior to gathering of said cellulose based tubular food casing, with a mixture comprising water, hydrogen peroxide, acetic acid and peracetic acid.

7. The method of claim 6 further comprising gathering the cellulose based tubular food casing after the treating step.

8. The method of claim 7 further comprising packaging the cellulose based tubular food casing in a protective package comprising a water-impermeable material, after the gathering step.
